(19) United States
(12) Patent Application Publication
(10) Pub. No.: US 2023/0133512 A1
(43) Pub. Date: May 4, 2023

(54) METHOD AND APPARATUS FOR PROVIDING NAVIGATION DIRECTIONS TO A DESTINATION

(71) Applicant: GENETEC INC., Saint-Laurent (CA)

(72) Inventor: CHRIS YIGIT, Pierrefonds (CA)

(73) Assignee: GENETEC INC., Saint-Laurent (CA)

(21) Appl. No.: 17/972,936

(22) Filed: Oct. 25, 2022

Related U.S. Application Data
(60) Provisional application No. 63/273,189, filed on Oct. 29, 2021.

(51) Int. Cl. G01C 21/36; G01C 21/34

(52) U.S. Cl. CPC G01C 21/3685; G01C 21/3438; G01C 21/3617

(57) ABSTRACT

A method of operating a processor of an electronic device for obtaining a navigation route to a destination. The method comprises obtaining a navigation request, the navigation request specifying the destination. The method further comprises obtaining requestor indicia associated with the navigation request, identifying a destination server based on at least one of the destination and the requestor indicia and providing the destination server with the requestor indicia to obtain from the destination server a sub-destination from a plurality of sub-destinations associated with the destination. Finally, the method comprises determining a navigation route to the sub-destination and causing the navigation route to such sub-destination to be output via a user interface as if it were the navigation route to the original destination. The requestor indicia may be requestor credentials identifying a specific user or a user class common to a plurality of users.

### CROSS-REFERENCE TO RELATED APPLICATION

The present application claims the benefit of U.S. Provisional Application Serial No. 63/273,189, filed on Oct. 29, 2021, hereby incorporated by reference herein.

### FIELD

The present disclosure relates generally to providing navigation directions to a destination and, more particularly, to computer-implemented methods for providing navigation directions to a specific parking zone associated with the destination.

### BACKGROUND

Businesses and other entities that have parking facilities with a large number of parking spaces often sub-divide their parking facilities into various physically distinct parking zones for use by different classes of users, e.g., executives, management, employees, visitors, disabled individuals, long-term vs short-term, paid or free, etc. This allows the parking resources to be distributed in accordance with the entity’s policies and values.

As work and travel habits change, such as resulting from the COVID-19 pandemic, so too has the demand for parking resources. Yet, the physical space occupied by parking facilities remains fixed. As a result, the parking zones developed previously may no longer represent a suitable and efficient distribution of the parking resources, and there is a need to re-shape former parking zones into new zones. Moreover, it may be necessary to re-shape these zones again in the future, in line with further changes in accordance with company policy or work habits.

While it may be feasible to reinstall and reposition bollards and/or signs to differentiate various parking zones from one another each time if there is a change, this is both expensive and inefficient. Businesses and other entities would therefore prefer to employ a method of keeping track of shifting zone limits in purely digital form. However, the effect of a digital solution on those using the parking facilities is unpredictable, since one day a user may be entitled to park in a certain location and the next day they may not. Quite simply, on any given day, the user does not know which parking zone they are allowed to use. This leads to frustration and confusion, which could cause the businesses and other entities to abandon a digital approach to re-shaping their parking zones.

Accordingly, it is desirable to provide a reliable solution to direct users to parking zones with greater efficiency and accuracy.

### SUMMARY

The present disclosure describes a method of providing a user, who is headed to a destination with a zone-based parking facility, with a sub-destination (e.g., cartographic coordinates of a parking lot or a parking space within the parking facility) in order to direct the user to a parking zone that is suitable for that user. This avoids the user arriving at a general entrance of the destination only to then determine, based on signage or other physical cues, where a suitable parking lot or zone may be. As a result, the present method may save the user time and energy, and may help to eliminate user’s anxiety to find parking when heading to a business or other entity with which the user may have a previous relationship. In some applications, digitally defined parking zones may be dynamically modified based on a demand factor, such as a class of user, class of commute type, time-of-day, day-of-week, or any suitable factor.

Thus, according to a first broad aspect, there is provided a method of operating a processor of an electronic device for obtaining a navigation route to a destination. The method comprises obtaining a navigation request, the navigation request specifying the destination. The method further comprises obtaining requestor indicia associated with the navigation request, identifying a destination server based on at least one of the destination and the requestor indicia and providing the destination server with the requestor indicia to obtain from the destination server a sub-destination from a plurality of sub-destinations associated with the destination. Finally, the method comprises determining a navigation route to the sub-destination and causing the navigation route to such sub-destination to be output via a user interface as if it were the navigation route to the original destination. The requestor indicia may be requestor credentials identifying a specific user or a user class common to a plurality of users.

According to another broad aspect, there is provided a method of operating a processor of an electronic device, comprising: capturing a navigation request entered via a user interface, the navigation request specifying a destination; obtaining requestor indicia; providing a destination server with the requestor indicia to obtain from the destination server a sub-destination from a plurality of sub-destinations associated with the destination; providing the sub-destination to a navigation application; and outputting via a user interface a navigation route received from the navigation application.

According to yet another broad aspect, there is provided a method of operating a server associated with a destination, comprising: obtaining requestor credentials from an electronic device over a data network; determining a user class based on at least the requestor credentials; determining a sub-destination associated with the destination; and causing the sub-destination to be sent to the electronic device over the data network.

Further, there is provided an apparatus (a mobile device or a server) comprising a processor and a non-transitory memory medium storing computer-readable instructions for execution by the processor, whereby the processor is configured to execute the computer-readable instructions to carry out any of the aforementioned methods. A computer readable storage medium having stored therein instructions, which when executed by a server, cause the server to carry out any of the aforementioned methods is also provided.

### BRIEF DESCRIPTION OF THE DRAWINGS

These and other aspects will now be described in greater detail with reference to the accompanying drawings, in which:

FIG. 1 is a schematic diagram of an example communication system in accordance with a non-limiting embodiment;

FIG. 2 is a block diagram illustrating an example processing system suitable for implementing a mobile device in the communication system of FIG. 1;

FIG. 3 is a flowchart illustrating an example navigation management process, in accordance with a non-limiting embodiment;

FIG. 4 is a block diagram illustrating an example processing system suitable for implementing a server in the communication system of FIG. 1;

FIG. 5 is a schematic view of an example parking zone database of a destination server, in accordance with a non-limiting embodiment;

FIGS. 6A and 6B are schematic views of an example user class database of a destination server, in accordance with non-limiting embodiments;

FIG. 7 is a flowchart illustrating an example sub-destination determination process, in accordance with a non-limiting embodiment;

FIG. 8 is a conceptual diagram illustrating interoperation between the navigation management process and the sub-destination determination process, in accordance with a non-limiting embodiment; and

FIG. 9 is an example screenshot presented to the user by the user interface process and providing the user with an opportunity to enter information.

The drawings are to be used as an aid in understanding various examples, notions and embodiments described in the present disclosure and are not to be considered limiting.

### DESCRIPTION OF EXAMPLE EMBODIMENTS

The methods and systems disclosed herein may be used in various applications, including when intending to find parking at a business or other entity, such as an airport, hospital, educational or corporate campus, or any suitable place that could be considered a “destination” by a user of an electronic device, particularly when that user is in a vehicle.

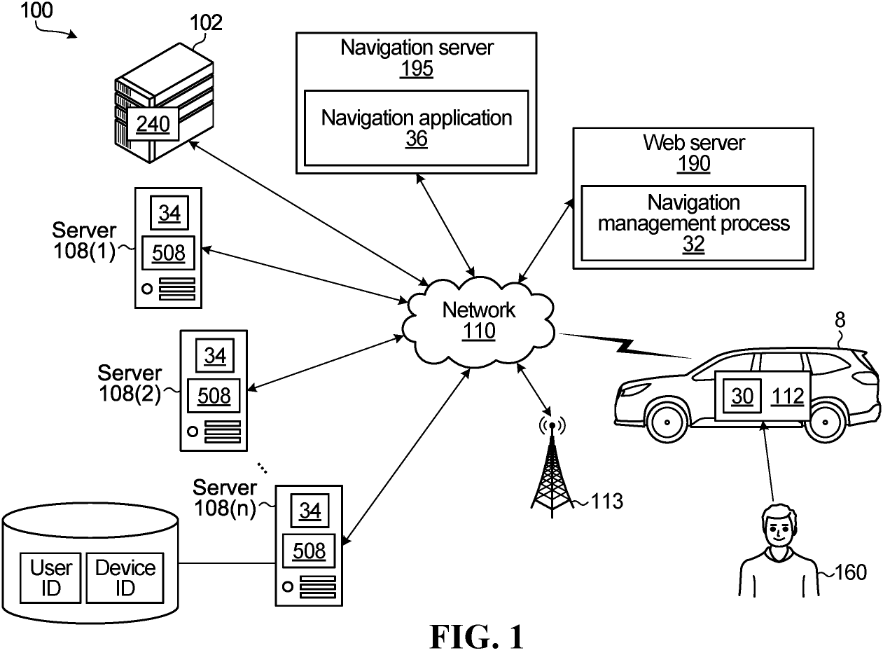

FIG. 1 is a schematic diagram illustrating an example communication system 100 in which a mobile device 112 and a plurality of servers 108(1)-(n), 190, 195 may communicate over a communication network 110. The communication network 110 could include or traverse a collection of public and private data networks such as the Internet. The communication system 100 can include multiple different types of other communication networks (not shown) connected directly or indirectly to the communication network 110.

The mobile device 112 is wirelessly connected to the communication network 110, enabling the mobile device 112 to access one or more services via the communication network 110, as provided by the servers 108(1)-(n), 190, 195. Accordingly, the mobile device 112 may establish a wireless connection with a wireless access point or base station 113, and this wireless access point or base station 113 may be connected to the remainder of the communication network 110 in a wireless or non-wireless fashion.

In example embodiments, the mobile device 112 is associated with at least one subscriber or primary user 160 who has a relationship (e.g., owns, rents, has been assigned, or is otherwise associated) with the mobile device 112. For example, a service provider server (e.g., server 108(2)) connected to the communication network 110 may store a database of users which maps an ID of the primary user 160 (e.g., a name, civic address, employer or social insurance number, to name a few non-limiting examples) with an ID of the mobile device 112 (such as a phone number, IP address or International Mobile Equipment Identity (IMEI), to name a few non-limiting examples).

In the example of FIG. 1, the mobile device 112 may be any component or collection of components capable of communicating over the communication network 110 and requesting navigation directions (which can be done on behalf of the user 160). For example, the mobile device 112 could be a smartphone, desktop, laptop, tablet, portable navigator, automotive navigation system (“GPS”) embedded in a vehicle 8, or any other suitably enabled mobile device.

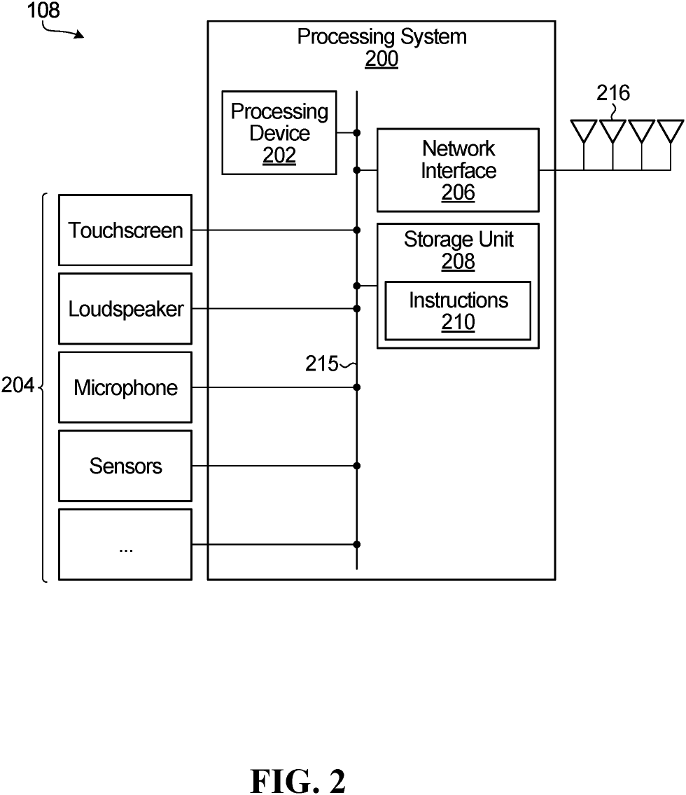

A possible configuration of the mobile device 112 will now be discussed in greater detail and with reference to the simplified block diagram of FIG. 2.

The mobile device 112 comprises a processing system 200. The example processing system 200 described below, or variations thereof, may be used to implement certain functionalities of the mobile device 112. However, other processing systems may be suitable for implementing the mobile device 112 and may include components different from those discussed herein. Although FIG. 2 shows a single instance of each component, there may be multiple instances of each component in the processing system 200.

The processing system 200 may include a processing device 202, such as a central processing unit (CPU), a graphics processing unit (GPU), a tensor processing unit (TPU), a neural processing unit (NPU), an application-specific integrated circuit (ASIC), a field-programmable gate array (FPGA), a dedicated logic circuitry, or combinations thereof.

The processing system 200 may further include a network interface 206 for wireless communication with the communication network 110. For example, the network interface 206 may be connected to an antenna 216, which enables wireless communications. The network interface 206 may also include a wireless transceiver, such as a cellular transceiver, configured for radio access networks (RAN) communications including cellular communications. The network interface 206 may further include a wireless local area network (WLAN) transceiver for communicating with a WLAN (not shown) of the communication network 110 via a WLAN access point (AP). In some applications, the network interface 206 may also comprise a wireless personal area network (WPAN) transceiver, such as a short-range wireless or Bluetooth^{®} transceiver, for communicating with a nearby Bluetooth^{®}-enabled device. The network interface 206 may also include an RFID or Near Field Communication (NFC) transceiver.

In some examples, the network interface 206 may comprise a satellite transceiver for receiving satellite signals from a satellite network (not shown in FIG. 1) that comprises a plurality of satellites that are part of a global or regional satellite navigation system in the communication network 100. The satellite signals can be used to determine a position of the mobile device 112. In at least some embodiments, the satellites are part of at least one Global Navigation Satellite System (GNSS) that provides autonomous geo-spatial positioning with global coverage. For example, the satellite network may be a constellation of GNSS satellites. Example GNSSs include the United States’ NAVSTAR Global Positioning System (GPS) or China’s BeiDou Navigation Satellite System (BDS), among others.

The processing system 200 may also include or have access to a storage unit 208, which may include a mass storage unit such as a solid state drive, a hard disk drive, a magnetic disk drive and/or an optical disk drive. Specifically, the storage unit 208 may include a volatile or non-volatile memory (e.g., a flash memory, a random-access memory (RAM), and/or a read-only memory (ROM)). The storage unit may store computer-readable instructions 210 for execution by the processing device 202, such as to carry out example processes or applications, including a user interface process, an operating system and other applications/functions. The memory storage unit 208 may also store various information pertaining to the mobile device 112 such as an International Mobile Equipment Identity (IMEI), an RFID identifier, a Bluetooth^{®} signature and so on.

The processing system 200 may be communicatively coupled to various user input/output (I/O) devices 204, to enable interfacing with the user 160. The I/O devices 204 may include a keyboard, a mouse, a microphone, a touchscreen integrated into a display device and/or a keypad, for receiving input from the user 160. The I/O devices 204 may also include at least one of a display and a loudspeaker, which provide audio and/or visual output to the user 160. The I/O devices 204 may further include sensors such as a radio frequency scanner, an NFC scanner and/or an RFID scanner to detect other mobile devices in the vehicle 8. In FIG. 2, the I/O devices 204 are shown as being external to the processing system 200. In other examples, one or more of the I/O devices 204 may be integrated together and/or with the processing system 200.

There may also be provided a bus 215 enabling communication among components of the processing system 200, including the processing device 202, I/O devices 204, network interface 206 and storage unit 208. The bus 215 may be any suitable bus architecture including, for example, a memory bus, a peripheral bus or a video bus.

The computer-readable instructions 210 may comprise instructions which, when executed by the processing device 202, cause the processing device 202 to carry out a user interface (UI) process 30. The user interface process 30 is attentive to input from the user 160 via the I/O devices 204 and provides output to he user via the I/O devices 204. The user interface process 30 may cause output to be provided in audio form (via the loudspeaker) and in visual form (via the screen). The user interface process 30 may cause user input to be received in tactile form (via the touchscreen), in audio form (via a microphone) and possibly in other ways (such as via a keyboard or mouse). In addition to managing user inputs and outputs to the user 160, the user interface process 30 is configured to send and receive relevant information over the communications network 112, as will be described in further detail later on.

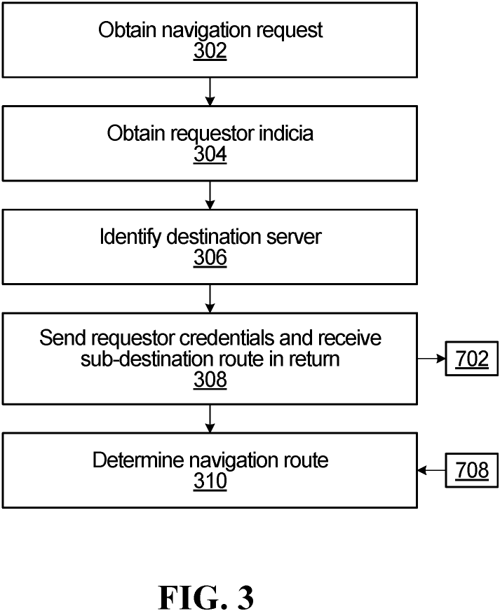

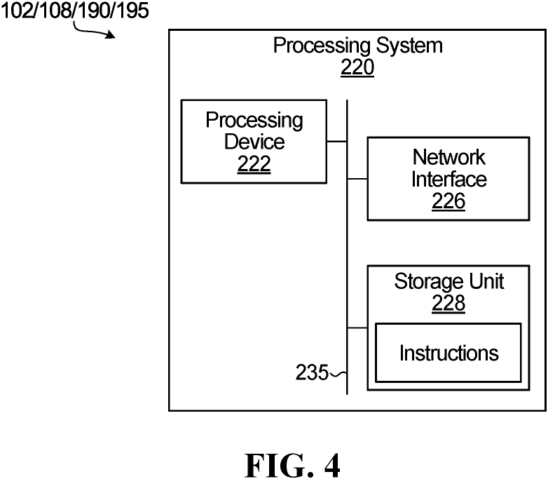

FIG. 4 is a block diagram of an example simplified processing system 220, which may be used to implement any of the servers 108(1)-(n), 190, 195. Components of the processing system 220 shown in FIG. 3 are similar to those of the processing system 200 shown in FIG. 2. A notable exception, however, is the absence of I/O devices. That is to say, the servers 108(1)-(n), 190, 195 might not include any display (including touchscreen), mouse, keyboard or microphone, as they might not be designed for interfacing directly with a user.

In this regard, the processing system 220 may include a processing device 222, such as a central processing unit (CPU), a graphics processing unit (GPU), a tensor processing unit (TPU), a neural processing unit (NPU), an application-specific integrated circuit (ASIC), a field-programmable gate array (FPGA), a dedicated logic circuitry, or combinations thereof. The processing system 220 may also include a network interface 226 for wired or wireless communication with the communication network 110 using any of a variety of protocols.

The processing system 220 may also include or have access to a storage unit 228, which may include a mass storage unit such as a solid state drive, a hard disk drive, a magnetic disk drive and/or an optical disk drive. Specifically, the storage unit 228 may include a volatile or non-volatile memory (e.g., a flash memory, a random-access memory (RAM), and/or a read-only memory (ROM)). The storage unit 228 may store computer-readable instructions 230 for execution by the processing device 222, thereby to carry out example processes described in the present disclosure, as well as an operating system and other applications/functions.

There may also be provided a bus 235 enabling communication among components of the processing system 220, including the processing device 222, network interface 226 and storage unit 228 . The bus 215 may be any suitable bus architecture including, for example, a memory bus, a peripheral bus or a video bus.

Certain distinctions exist among the servers 108(1)-(n), the server 190 and the server 195, as will now be discussed in greater detail.

In a non-limiting embodiment, each of the servers 108(1)-(n) may be associated with a respective business or entity that is a potential destination from the perspective of the user 160. As such, servers 108(1)-(n) can be referred to as “destination servers”. Each of the destination servers 108(1)-(n) may this be managed by a different respective business or entity and manage the parking resources associated with that business or entity.

Consider destination server 108(M), which is associated with a destination having a certain destination identifier (e.g., a civic address or a business name), hereby simplified as “Destination M”. From a functional point of view, destination server 108(M) is configured to receive requestor indicia from a requesting entity (such as the mobile device 112) over the communication network 110 and to output a sub-destination (from a plurality of possible sub-destinations associated with Destination M) in response thereto. This process can be referred to as a sub-destination determination process 34. The sub-destination determination process 34 may involve consulting a parking zone database 502 and a user class database 504 stored in the storage unit 228 of destination server 108(M).

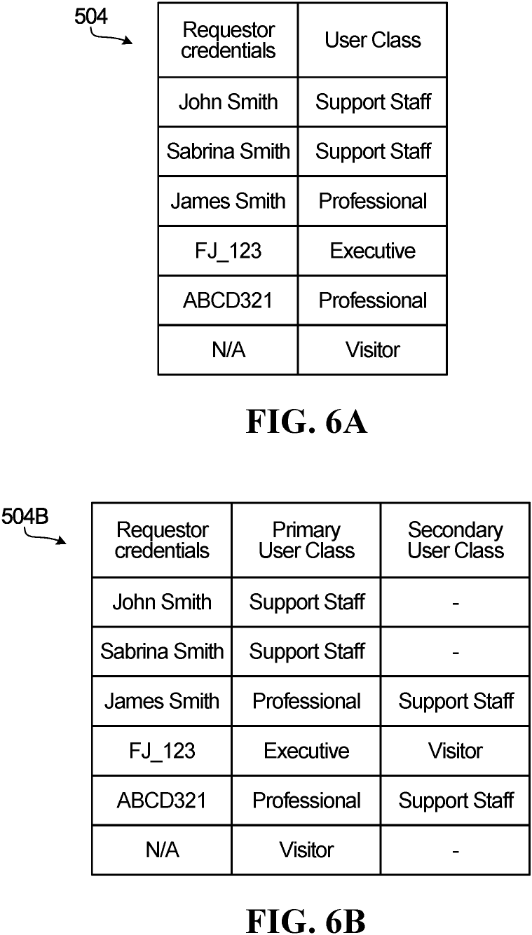

With reference to FIG. 6A, the user class database 504 stores mapping relationships between “requestor credentials” and “user classes” (also referred to as a “travel indicator”). The “requestor credentials” can refer to identification information that uniquely identifies users and/or the vehicles in which they are traveling. Non-limiting examples of requestor credentials may include at least one of a personal name, an email address, an employee number, a telephone number, a username, a password, a vehicle serial number (VIN) and a vehicle license plate number.

On the other hand, the “user class” refers to a class or type of user as determined and/or maintained by destination M according to the nature of the organization, its policies and its value system. Non-limiting examples of user classes where destination M is a hospital could include: “staff – doctor”, “staff – medical non-doctor”, “staff – administrative”, “visitor”, “delivery”, “disabled” and “family”. Non-limiting examples of user classes where destination M is a business could include “management”, “employee”, “contractor”, “delivery”, “customer” and “visitor”. It is noted that the user class does not uniquely identify users or vehicles, but rather is used to designate a characteristic, behavior or intent shared by multiple users or vehicles.

It is noted that the requestor indicia (i.e., as received from a requesting entity, such as the mobile device 112, over the communication network 110) may comprise requestor credentials or a user class. More specifically, the user 160 can identify themselves (or their vehicle) on an individual basis by causing the requestor indicia to include requestor credentials that would already be stored in the user class database 504 of the destination server 108(M) associated with the business or other entity where the user 160 is headed. In such cases, the received requestor credentials will already be known to destination server 108(M) in advance and will be pre-associated with a user class. However, in other cases, the user 160 may not want to or be able to provide such requestor credentials, e.g., if the user 160 does not have a previous relationship with the destination business or other entity. In that case, the requestor indicia may specify the broader user class (e.g., “visitor”, “delivery”, etc.) instead of specific per-user requestor credentials. In still other cases, the requestor indicia provided by the mobile device 112 may be null indicia, which could be considered as being mapped to a default user class such as the “visitor” user class.

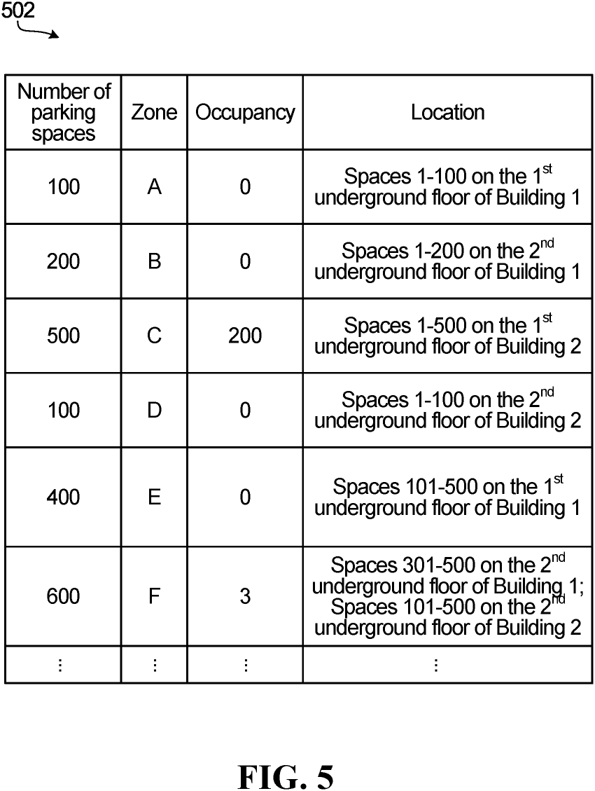

With reference to FIG. 5, the parking zone database 502 stores mapping relationships between “user class”, “zone”, “number of parking spaces”, “occupancy” and “location”. The “zone” refers to a set of parking spaces that are logically grouped but are physically disparate and are associated with a certain user class. A size of a respective zone depends on the number of parking spaces within the parking zone. The size, location and/or extent of a zone associated with each user class may be varied dynamically as will be described later on. In the non-limiting example of FIG. 5, 100 parking spaces in zone A are allocated for professionals of destination M. These 100 parking spaces are located at spaces 1-100 on the first underground floor of Building 1. 200 parking spaces in zone B are allocated for support staff. A location of zone B includes spaces 1-200 on the second underground floor of Building 1, and so on.

In a non-limiting embodiment, server 195 is a navigation server that receives identifying information about a destination (e.g., a civic address or cartographic (e.g., latitude/longitude) coordinates) as well as a given starting point, and provides navigation directions (e.g., a navigation route) to the destination from the given starting point, based on traffic conditions, road closures, etc. To this end, navigation server 195 may run a navigation application 36. Non-limiting examples of a navigation application 36 include Google Maps and Waze, although other navigation applications 36 will be known to those of skill in the art.

In a non-limiting embodiment, server 190 is a web server that interfaces with the mobile device 112 over the communication network 110. Web server 190 executes a navigation management process 32, which involves contacting one of the destination servers 108(1)-(n) over the communication network 110 and also contacting the navigation server 195 over the communication network 110 as will be described in further detail below.

The present disclosure describes example methods that provide a navigation route to an available parking zone for a destination where the user 160 is headed. The disclosed methods may be used in various applications, including but not limited to implementation in an autonomous driving system. In one embodiment, providing a navigation route involves interaction among the user interface process 30 carried out by the mobile device 112, the navigation management process 32 carried out by the web server 190, the sub-destination determination process 34 carried out by one or more of the destination servers 108(1)-(n) and the navigation application 36 carried out by the navigation server 195.

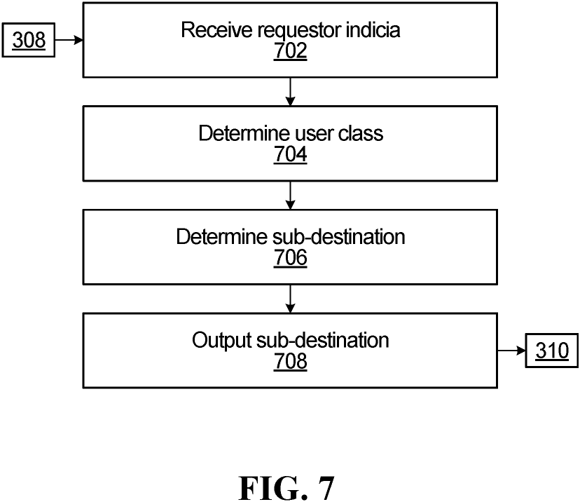

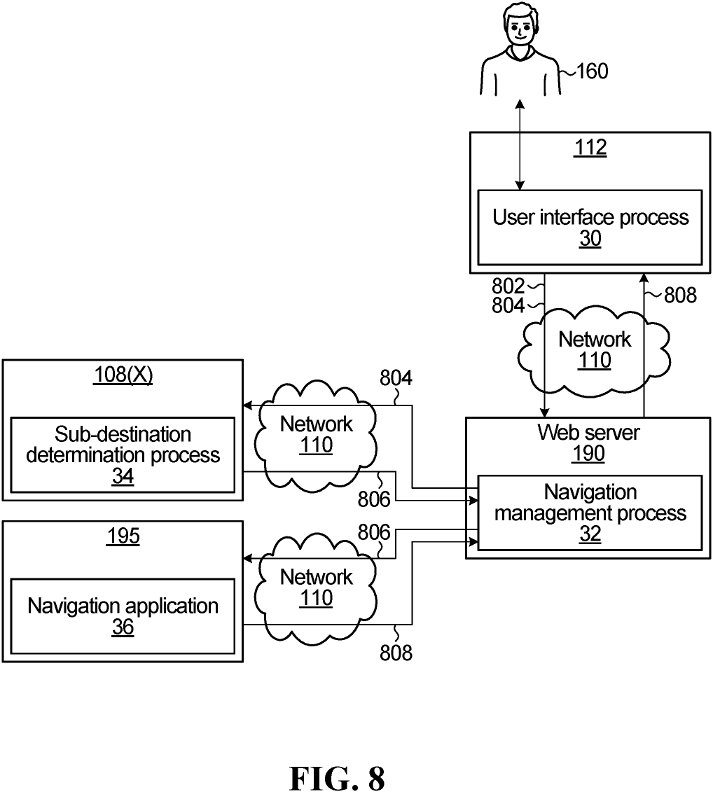

Accordingly, interoperation among the aforementioned processes is now described with reference to FIG. 3 (showing steps in the navigation management process 32), FIG. 7 (showing steps in the sub-destination determination process 34) and FIG. 8 (conceptually illustrating the interoperation among the user interface process 30, the navigation management process 32, the sub-destination determination process 34 and the navigation application 36).

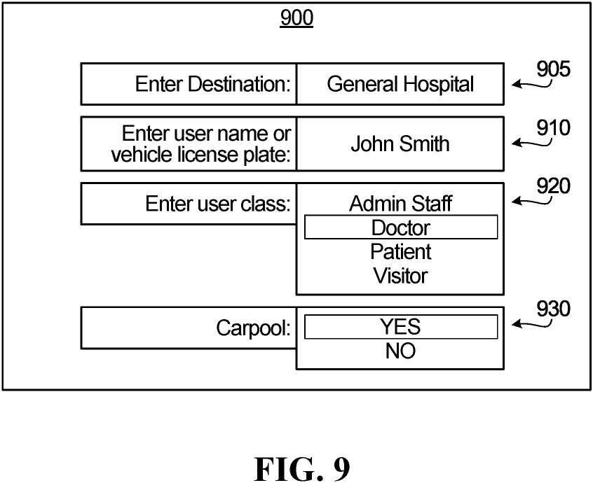

At step 302 of the navigation management process 32, a navigation request 802 specifying a destination is obtained, e.g., from the user 160 via the user interface process 30. To this end, and as shown in FIG. 9, the user interface 30 may be configured to display a screen 900 with a box 905 into which the user 160 may enter the destination (in this case “General Hospital”). The destination may be identified by a civic address or a name of a business, landmark or other indicia. In one non-limiting embodiment, the navigation request 802 may include a message sent from the mobile device 112 to web server 190 over the communication network 110.

At step 304 of the navigation management process 32, requestor indica 804 are obtained. In some embodiments, the requestor indicia 804 may include requestor credentials that uniquely identify the user 160 and/or the vehicle 8 that the user 160 is using. Such requestor credentials may include at least one of a personal name, an email address, an employee number, a telephone number, a username, a password, a vehicle serial number (VIN), a vehicle license plate, and/or any other suitable identity information that identifies the user 160. In other embodiments, the requestor indicia 804 may include a user class that does not uniquely identify the user 160 or the vehicle 8, but rather a function or intent of the user 160, such as “delivery”, “visitor”, “pregnant” or “disabled”. In still other embodiments, the requestor indicia 804 may be null indicia.

In some embodiments, the requestor indicia 804 may be obtained from the user 160 via the user interface process 30. To this end, and as shown in FIG. 9, the user interface 30 may be configured to display a screen 900 with a box 910 into which the user 160 may enter his or her name or license plate (in which case the entered requestor credentials could be used as the requestor indicia 804). The screen 900 may also provide a menu 920 of user classes from which the user 160 may select a user class (in which case the entered user class could be used as the requestor indicia 804). In some cases, the requestor indicia 804 may include the requestor credentials (in this case, “John Smith”) and the user class (in this case, “doctor”) entered by the user 160 in the box 910 and the menu 920, respectively.

In one non-limiting embodiment, the requestor indicia 804 may form part of message sent from the mobile device 112 to web server 190 over the communication network 110. In some embodiments, the requestor indicia 804 may be part of the navigation request 802, i.e., the navigation request 802 is bundled together with the requestor indicia 804.

At step 306 of the navigation management process 32, a destination server for the destination forming part of the navigation request 802 obtained at step 302 is identified, e.g., by its network address. The identified destination server may be one of the destination servers 108(1)-(n). For the purposes of the present example, let the identified destination server be destination server 108(X).

There are various ways in which destination server 108(X) can be identified as the destination server associated with the current navigation request 802.

In one specific non-limiting embodiment, destination server 108(X) is identified based on the fact that it is associated with the destination specified in the navigation request 802. In other words, different possible destinations are associated with different destination servers. Knowledge of which destination servers are associated with which destinations may be stored in the storage unit of the device executing the navigation management process 32 (e.g., the storage unit 228 of web server 190).

In another specific non-limiting embodiment, destination server 108(X) is identified based on the fact that it is associated with the requestor indicia 804. In other words, different users are known to be associated with different destination servers. In this case, knowledge of which destination servers are associated wit which users may be stored in the storage unit 208 of the mobile device 112. This may be the case where a first user and a second user share the vehicle 8 but work for different companies, and on days when it is the first user driving the vehicle 8, the user interface process 30 knows to access a first one of the destination servers 108(1)-(n) and on days when it is the second user driving the vehicle 8, the user interface process 30 knows to access a second one of the destination servers 108(1)-(n).

At step 308 of the navigation management process 32, destination server 108(X) is provided with the requestor indicia 804 obtained at step 304 and, in return, a sub-destination 806 from a plurality of potential sub-destinations associated with the destination is obtained. This involves execution of the sub-destination determination process 34 at destination server 108(X), starting with step 702.

Specifically, at step 702 of the sub-destination determination process 34, the requestor indicia 804 are received at destination server 108(X). This may accord by way of a message sent from web server 190 to destination server 108(X) over the communication network 110. It is noted that the requestor indicia 804 may include requestor credentials (uniquely identifying the user 160 or the vehicle) or a user class or may be null indicia.

At step 704 of the sub-destination determination process 34, destination server 108(X) determines a user class based on the requestor indicia 804. Naturally, if the requestor indicia 804 already specifies a user class then this step does not need to be performed. On the other hand, if the requestor indicia 804 includes requestor credentials, the user class obtained through execution of step 704 will correspond to a type of user having such requestor credentials. In this case, the user class may be selected from a set of user classes that may depend on the nature of the organization associated with destination server 108(X). In a non-limiting example, the user classes could be based on position in the company hierarchy. In another non-limiting example, the user classes may be indicative of a priority, such as “high priority” or “low priority”. To determine the user class based on requestor credentials, destination server 108(X) may consult the user class database 504 stored in the memory 228 of destination server 108(X).

In some cases, although the requestor indicia 804 may include requestor credentials, these requestor credentials might not be locatable in the user class database 504. In one embodiment, the sub-destination determination process 34 may be configured, under such a scenario, to ascribe the requestor credentials to a default user class such as a “visitor” user class (which can also be the course taken when the requestor indicia are null indicia). In an alternative embodiment, in the event that the requestor credentials are not recognized or found in the user class database 504, the navigation management process 32 may be configured to request confirmation of the requestor credentials from the user 160 before proceeding to ascribe them to the visitor user class. This can be done by a message exchange between the navigation management process 32 and the user 160 via the user interface process 30 of the mobile device 112. This may be beneficial to avoid undesirable situations. For example, this could avoid the situation where a mistake was made by the user 160 when entering the requestor credentials (e.g., via the window 910) and where the user 160 and/or the vehicle 8 is actually not a visitor (and should not be ascribed to the “visitor” user class), which would otherwise result in aggravation (and potentially a fine) if the vehicle 8 were to park in a zone reserved for visitors.

At step 706 of the sub-destination determination process 34, destination server 108(X) determines the sub-destination 806 based on the user class determined at step 704. The sub-destination 806 can be determined by consulting the parking zone database 502 stored in a memory (e.g., the storage unit 228) of the destination server 108(X). In some examples, the sub-destination 806 may specify the civic address or cartographic coordinates of a particular parking zone (which could be a parking lot, a subset of parking spaces or even a single parking space, for example).

In some embodiments, the sub-destination determination process 34 may be configured to locate an empty parking space in the particular parking zone. This can be done by monitoring occupancy of the various zones in order to keep track of which parking spots are occupied and which parking spots are vacant. In some cases, identifying information (such as license plate) can be used to not only assess which parking spots are taken but also which user has taken it. In other embodiments of step 706, and specifically where the requestor indicia 804 includes requestor credentials (e.g., in the case of a license plate, which may be associated to an employee ID), the sub-destination determination process 34 may be configured to reserve a specific parking spot for such requestor credentials, and this information may supplement the information stored in the parking zone database 502. In this case, a security system with access to the parking zone database 502 can assess whether parking spaces that have been allocated to certain license plates (or user IDs) are occupied by a legitimate vehicle or not.

At step 708 of the sub-destination determination process 34, destination server 108(X) outputs the sub-destination 806 to the device or entity executing the navigation management process 32 (in this case, web server 190). For example, this can be done by way of destination server 108(X) sending a message to web server 190 over the communication network 110. Additionally, the sub-destination determination process 34 may be configured to update the parking zone database 502 in the storage unit 228, notably the occupancy field, to indicate that an additional parking spot is taken. Since this may be done before the vehicle 8 is actually parked or without proof that the vehicle 8 has taken up a space in the determined parking zone, occupancy could be corroborated by a video camera surveillance and vehicle counting software.

At step 310 of the navigation management process 32, a navigation route 808 to the sub-destination 806 is determined from a starting point. This may be done by providing the sub-destination 806 (e.g., civic address or cartographic coordinates of a parking zone) and the starting point to the navigation application 36 run by navigation server 195. The starting point for the navigation route 808 may be the current location of the mobile device 112, which can be provided to web server 190 and/or to navigation server 195. The current location of the mobile device 112 may be determined from a navigation system mounted to the vehicle 8 or embedded in the mobile unit 112 and transmitted to wen server 190 in a message transferred over the communication network 110. The navigation application 36 may use a combination of global positioning system (GPS), Wi-Fi techniques, and/or cell towers to determine the navigation route 808 to the sub-destination 806 from the starting point.

The navigation route 808 may then be returned to the device executing the navigation management process 32 (e.g., in this case, web server 190), which may then cause the navigation route 808 to be displayed to the user 160 via the user interface process 30 of the mobile device 112.

At this point, the user 160 may drive or navigate the vehicle 8 in accordance with the navigation route 808 so as to reach the sub-destination associated with the initially specified destination. In this way, the user 160 avoids the extra time, effort and frustration arising from showing up at the main entrance of the initially specified destination, only to realize that further travel is needed in order to find a parking spot in a parking zone for which the user is eligible. Those skilled in the art will appreciate that the navigation route 808 may be fed to a guidance system of an autonomous vehicle, which can then proceed autonomously towards the sub-destination by following the navigation route 808. This is particularly feasible where the mobile device 112 and the guidance system are interconnected to each other and to the vehicle’s electronic control unit (ECU).

In some examples, the navigation route 808 is one of a plurality of candidate navigation routes to the sub-destination 806 that are determined by the navigation application 36. The user 160 may select the navigation route 808 from the plurality of candidate navigation routes, e.g., by a selection made using the input/output devices 204. Selection may be done automatically by the electronic device 112 and/or by the navigation application 36 based on distance, time and/or energy efficiency considerations.

In the above-described embodiments, the navigation management process 32 is executed by the web server 190, whereas the mobile device 112 may be a smartphone incorporating a web browser for accessing the web server 190. In other embodiments, the navigation management process 32 may be executed by the mobile device 112 itself. In other words, some of the computer-readable instructions 210 in the storage unit 208 of the mobile device 112 may include instructions which, when executed by the processing entity 202, cause the processing entity 202 to carry out the navigation management process 32.

It is also recalled that in some embodiments, the mobile device 112 may be an on-board GPS of the vehicle 8. In this scenario, the on-board GPS has access to the vehicle ECU (electronic control unit), which could ensure that the correct requestor credentials are provided. In other words, if the requestor indicia includes vehicle-related requestor credentials 804 such as a license plate or VIN, this information could be stored by the ECU and retrieved by the on-board GPS without requiring such information to be entered by the user 160. As such, by having the on-board GPS obtain the requestor credentials without user intervention, this reduces the ability of the user 160 to enter false requestor credentials in an attempt to gain access to a preferential parking zone.

It should also be understood that the navigation application 36 can be executed by the same device as the navigation management process 32, for example by the mobile device 112. In this way, the navigation management process 32 and the navigation application 36 can be combined to yield an enhanced navigation application. This applies both to the case where the mobile device 112 is part of the vehicle 8 (e.g., an on-board GPS) and to the case where the mobile device 112 is independent of the vehicle 8 (e.g., a smartphone).

In some embodiments of step 306, the entity executing the navigation management process 32 (e.g., web server 190 or the mobile device 112) may be unable to identify a destination server based on the information provided in the navigation request 802 or in the requestor indicia 804. In such a scenario, the communication system 100 may comprise or have access to a “server identification database” 102 (shown in FIG. 1), which may be configured so as to be reachable over the communication network 110 at a predetermined network address (e.g., a website) that is known to the web server 190, to the mobile device 112 or to the user 160. The server identification database 102 may store a server database 240 which maintains an association between a plurality of destinations (e.g., business names, civic addresses, landmarks, etc.) and network addresses at which corresponding destination servers 108(1)-(n) for those destinations can be reached.

In this scenario, the entity executing the navigation management process 32 (e.g., web server 190 or the mobile device 112) may establish a suitable communication link with the server identification database 102 over the communication network 110. (The storage unit 228 of web server 190 may be pre-configured to store the network address of the server identification database 102.) The entity executing the navigation management process 32 (e.g., web server 190 or the mobile device 112) may be configured to query the server identification database 102 with the initial destination entered by the user 160 via the user interface process 30 and obtain, in return, the network address of the corresponding destination server, say destination server 108(X).

Specifically, the server identification database 102 consults the server database 240 stored internally by utilizing the initially specified destination to identify a network address (e.g., an internet protocol (IP) address) of a server (e.g., the server 108(X)) which manages a plurality of sub-destinations associated with the initially specified destination. The server identification database 102 may send a return message to web server 190 or the mobile device 112 over the communication network 110 indicating the identified IP address and/or an identifier (ID) of the identified destination server 108(X). Web server 190 or the mobile device 112 then contacts the identified destination server 108(X) at the obtained IP address, from which a sub-destination is retrieved, as per step 308 described above.

Those skilled in the art will appreciate that the user class database 504 discussed in FIG. 6 maps relationships between requestor credentials and user classes. This is particularly applicable to the case where the requestor credentials, but not the user class, are supplied to the navigation management process 32. However, this is merely illustrative and not intended to be limiting. In other examples, it is the user class that may be provided to the navigation management process 32 as part of the navigation request 802, for example. Specifically, the user 160 may know their associated user class in advance and may provide it via the user interface process 30 of the mobile device 112. For example, the user interface process 30 may be configured to provide a dialog box that provides the user 160 with an opportunity to enter a user class, e.g., from a drop-down menu 920 of user classes (such as executive, professional, admin, visitor, etc.). In this case, destination server 108(X) may directly proceed to access the parking zone database 502 in order to determine the zone based on the user class supplied by the user 160, which could eliminate the need for the user class database 504. However, this preferentially requires a certain trust relationship to exist between destination server 108(X) and the mobile device 112 (or the user 160) so as to minimize the chances that the user class being sent by the mobile device 112 to destination server 108(X) is incorrect or fraudulent.

Those skilled in the art will appreciate that the number of parking places per zone is limited and that in some cases, the parking zone associated with a user class may become full. In that case, the present disclosure provides for a mechanism to associate requestor credentials with a primary user class and a secondary user class, whereby the secondary user class is used as the user class in the parking zone database 502 under certain conditions, e.g., only if the parking zone associated with the primary user class is full. Accordingly, FIG. 6B shows a user class database 504B which provides for a primary user class and a secondary user class for some of the requestor credentials. Choosing which secondary user to ascribe to a given set of requestor credentials can be done based on policy considerations. It is noted that not all requestor credentials have both a primary user class and a secondary user class.

It is also noted that one of the user classes referred to in the parking zone database 502, and which may or may not be in the user class database 504, may include a “carpool” user class. For example, the “carpool” user class might not be known in advance for particular requestor credentials, but rather is determined dynamically, on a per-use basis, each time a new navigation request 802 is made. Specifically, the navigation request 802 may include one or more “supplemental travel indicators” that could assist with proper determination of the user class by the sub-destination determination process 34. The user interface process 30 implemented by the mobile device 112 may thus be configured to elicit one or more supplemental travel indicators from the user 160.

This can be done by the user interface process 30 being configured to ask the user 160 whether the user 160 is carpooling. With reference to FIG. 9, the user interface process 30 may be configured to interact with the user 160 via a box 930 in which the user 160 is given an opportunity to advise the system that he user 160 is carpooling. If the user responds or selects YES via the window, then the “carpool” supplemental travel indicator is set. The supplemental travel indicator may be communicated from the mobile device 112 to web server 190 and/or from web server 190 to destination servers 108(1)-(n) by way of a message sent over the communication network 110.

As mentioned above, one non-limiting example of a supplemental travel indicator is “carpooling”. The carpooling supplemental travel indicator is indicative of the fact that the user 160 is carpooling. The sub-destination determination process 34 takes into consideration the “carpool” supplemental travel indicator when determining the user class associated with the requestor indicia. For example, as shown in FIG. 6A, the user class stored in the user class database 504 for John Smith may be “support staff”. However, with the carpool supplemental travel indicator being received with the navigation request 802, the sub-destination determination process 34 may change the user class for John Smith from “support staff” to a new user class, which could be “support staff – carpool” or simply “carpool”. It is this new user class which is then set as the user class in the lookup in table 504 in association with John Smith, resulting in preferential parking treatment for John Smith, e.g., if the organization associated with the destination places value on carpooling. Preferential parking treatment could mean that the parking zone associated with the “support staff - carpool” user class is closer to a main entrance or has wider spots or is closer to an exit of the parking lot or is indoors or is closer to the ground floor, for example.

To ensure sound management of parking resources for carpooling, additional verification may be requested by the user interface process 30 in case the user 160 has expressed an intention to carpool (e.g., via the box 930). For example, the user interface process 30 may request requestor credentials from other users in the vehicle 8. In another example, the user interface process 30 may request a carpooling code from the user 160 via a window on the screen or via audio feedback. In a further example, the user interface process 30 may scan (via sensors) for wireless identifiers such as Bluetooth signatures or RFID identifiers or IMEIs of mobile devices in the vehicle 8.

It should be appreciated that the parking zones associated with different user classes need not be mutually exclusive, but rather they may spatially overlap, accordingly to organizational policies and hierarchical considerations. For example, the parking zones associated with a higher positioned user class may encompass all the parking spots associated with a lower positioned user class as well as other parking spots not associated with any lower positioned user class. In another example, two parking zones associated with different user classes may each be associated with mutually exclusive subsets of parking spots and there may be a third subset of parking spots that belong to the first parking zone and to the second zone simultaneously. Also, the parking spots within any given parking zone need not be contiguous.

The above methods and processes thus provide a navigation route to a sub-destination of an initially specified destination. This allows unprecedented flexibility in responding to changes in parking demand, organizational policy and user class.

In particular, the existence of the parking zone database 502 for a particular destination allows the organization associated with the particular destination to modify the location and number of parking spots associated with each user class and to create new user classes (or eliminate obsolete user classes) according to parking demand, organizational policy and other factors. These factors could include time of day, day of week, occurrence of a special event, construction work, weather (e.g., snow accumulation and removal), schedule changes, enviro-conscious factors, employee incentive programs, and so on. As a result, the same user headed for the same destination under two different sets of circumstances or factors could be directed to two different sub-destinations, e.g., to two different parking zones on two different occasions.

In addition, the existence of the user class database 504 allows the organization associated with the particular destination to update and keep track of changes in each user’s user class. This could arise as a user’s position evolves in the company, whether the user has acquired or paid for certain privileges, and so on. As a result, for example, a user who receives a promotion may be directed by the system to two different parking zones on the day before their promotion and the day following their promotion.

Management of the contents of the parking zone database 502 and the user class database 504 can be carried out by a parking policy manager 508 (shown in FIG. 1) implemented by the destination servers 108(1)-(n) associated with the various destinations. The parking policy manager 508 may be a functional process carried out by computer-readable instructions stored in the storage unit 228 of the destination servers 108(1)-(n). The parking policy manager 508 implemented by a given destination server associated with a given destination can be configured to monitor parking demand and parking trends at the given destination and dynamically reshape the locations and sizes of various parking zones associated with various user classes to optimize the parking resources on the basis of availability, equity, environmental considerations or other policy objectives. These objectives may be stored in the storage unit 228 of the given destination server. For example, these objectives may specify that users who carpool are given higher priority, which could translate by the parking policy manager grouping a number of parking spaces into a parking zone that is closer to the main entrance of the building associated with the given destination and associating this parking zone with the carpool user class. In other embodiments, the parking policy manager 508 could determine vacancy or occupancy of each parking zone and dynamically modify a size or geographic demarcation of each parking zone, to account for changes in occupancy and/or company policy.

Thus, it will be appreciated that the present disclosure depicts a method of identifying a sub-destination selected from one or more parking zones associated with a destination. Because the sub-destination is determined as a function of requestor indicia (which could be requestor credentials or user class), rather than simply corresponding to the address of the general entrance of the destination that the user may be interested in, the sub-destination may be more suitable for the user. In some applications, sizes, association, and/or geographic demarcations of parking zones may be dynamically modified based on parking demand, time-of-day occupancy, day-of-week occupancy, occupancy of each zone, and/or any other suitable factor. In addition, priorities are set to be associated with various supplemental travel indicators such as carpooling. This may help to ensure that carpooling commuters have an easier time finding parking or are assigned better parking zones, thus significantly reducing the anxiety of looking for a parking space in a busy parking area. This may also encourage eco-friendly traveling (e.g., carpooling).

In some examples, each of the destination servers 108(1)-(n) may manage sub-destinations associated with a respective destination. In other possible examples, a single destination server may mange sub-destinations associated with two or more destinations.

In the illustrated embodiment, the destination servers 108(1)-(n) and/or the server identification database 102 may wirelessly interface with the mobile device 112 directly or indirectly to communicate with each other through the communication network 110. In some examples, the server database 240, the parking zone database 502 and/or the user class database 504 may be stored additionally or alternatively at the mobile device 112.

The present disclosure is made with reference to the accompanying drawings, in which embodiments are shown. However, the description should not be construed as limited to the embodiments set forth herein. Rather, these embodiments are provided so that this disclosure will be thorough and complete. Moreover, separate boxes or illustrated separation of functional elements or modules of illustrated systems and devices does not necessarily require physical separation of such functions or modules, as communication between such elements can occur by way of messaging, function calls, shared memory space, and so on, without any such physical separation. As such, functions or modules need not be implemented in physically or logically separated platforms, although they are illustrated separately for ease of explanation herein. Different devices can have different designs, such that while some devices implement some functions in fixed function hardware, other devices can implement such functions in a programmable processor with code obtained from a machine-readable medium.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, certain technical solutions of the present disclosure may be embodied in the form of a software product. A suitable software product may be stored in a pre-recorded storage device or other similar non-volatile or non-transitory computer readable medium, for example. The software product includes instructions tangibly stored thereon that enable a processing device (e.g., a microprocessor) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method of operating a processor of an electronic device for obtaining a navigation route to a destination, the method comprising:
obtaining a navigation request, the navigation request specifying a destination;
obtaining requestor indicia associated with the navigation request;
identifying a destination server based on at least one of the destination and the requestor indicia;
providing the destination server with the requestor indicia to obtain from the destination server a sub-destination from a plurality of sub-destinations associated with the destination;
determining a navigation route to the sub-destination; and
causing the navigation route to be output via a user interface.

2. The method defined in claim 1, wherein the requestor indicia comprises requestor credentials uniquely identifying the requestor among a plurality of requestors.

3. The method defined in claim 2, wherein the requestor credentials uniquely identify a user.

4. The method defined in claim 2, wherein the requestor credentials uniquely identify a vehicle.

5. The method defined in claim 2, wherein the requestor credentials include at least one of a personal name, an email address, an employee number, a telephone number, a username, a password, a vehicle serial number, a vehicle license plate and a wireless identifier.

6. The method defined in claim 1, wherein the requestor indicia comprises a user class that does not uniquely identify the requestor.

7. The method defined in claim 1, further comprising obtaining the requestor indicia from the requestor via the user interface.

8. The method defined in claim 1, further comprising retrieving the requestor indicia from a memory of the electronic device.

9. The method defined in claim 1, wherein the sub-destination corresponds to a parking zone selected from a plurality of parking zones associated with the destination.

10. The method defined in claim 9, wherein the parking zone comprises a parking lot.

11. The method defined in claim 9, wherein the parking zone comprises a parking space.

12. The method defined in claim 1, wherein the destination specifies a civic address or a business name and wherein identifying the destination server based on the destination comprises determining a network address associated with the civic address or the business name, the network address being a network address of the destination server.

13. The method defined in claim 1, wherein the identifying comprises communicating with a server identification database at a predetermined network address and obtaining a network address of the destination server from the server-identification database.

14. The method defined in claim 1, wherein the destination server is reachable over a data network at a network address, wherein providing the destination server with the requestor credential comprises wirelessly sending the requestor credentials to the destination server over the data network at the network address of the destination server, the sub-destination being obtained wirelessly from the destination server over the data network.

15. The method defined in claim 1, wherein the destination specifies a civic address or a business name and wherein the sub-destination specifies a civic address or cartographic coordinates.

16. The method defined in claim 1, wherein the navigation request is obtained from a user through the user interface.

17. The method defined in claim 1, wherein the requestor credentials are obtained from a user through the user interface.

18. The method defined in claim 1, wherein the sub-destination depends on whether the requestor credentials are known to the destination server.

19. The method defined in claim 1, wherein the navigation request is received from a mobile device transported by a vehicle and wherein the navigation request is indicative that the vehicle is carpooling.

20. The method defined in claim 19, further comprising validating that the vehicle is carpooling based on additional information collected from the vehicle.

21. The method defined in claim 18, wherein the sub-destination is dependent on whether or not the navigation request is indicative that a user of the mobile device is carpooling.

22. The method defined in claim 21, further comprising casing the user interface to elicit from a user an indication of whether the user is carpooling.

23. The method defined in claim 1, the sub-destination being an initial sub-destination, the method further comprising:
obtaining a new navigation request, the new navigation request specifying said destination;
providing said destination server with said requestor credentials to obtain from said destination server a new sub-destination from said plurality of sub-destinations associated with said destination;
wherein the new sub-destination is different from said initial sub-destination.

24. The method defined in claim 1, carried out by a mobile device.

25. The method defined in claim 1, carried out by a web server.

26. An electronic device, comprising:
a processor;
a non-transitory memory medium storing computer-readable instructions for execution by the processor;
the processor configured to execute the computer-readable instructions to carry out a user interface process for:
obtaining a navigation request via the user interface, the navigation request specifying a destination;
obtaining requestor indicia associated with the navigation request;
identifying a destination server based on at least one of the destination and the requestor indicia;
providing the destination server with the requestor indicia to obtain from the destination server a sub-destination from a plurality of sub-destinations associated with the destination;
determining a navigation route to the sub-destination; and
causing the navigation route to be output via the user interface.

27. A computer readable storage medium having stored therein instructions, which when executed by a device, cause the device to carry out a method that comprises:
obtaining a navigation request, the navigation request specifying a destination;
obtaining requestor indicia associated with the navigation request;
identifying a destination server based on at least one of the destination and the requestor indicia;
providing the destination server with the requestor indicia to obtain from the destination server a sub-destination from a plurality of sub-destinations associated with the destination;
determining a navigation route to the sub-destination; and
causing the navigation route to be output via a user interface.

28. A method of operating a processor of an electronic device, comprising:
capturing a navigation request entered via a user interface, the navigation request specifying a destination;
obtaining requestor indicia;
providing a destination server with the requestor indicia to obtain from the destination server a sub-destination from a plurality of sub-destinations associated with the destination;
providing the sub-destination to a navigation application; and
outputting via a user interface a navigation route received from the navigation application.

29. (canceled)

30. (canceled)

31. A method of operating a server associated with a destination, comprising:
obtaining requestor credentials from an electronic device over a data network;
determining a user class based on at least the requestor credentials;
determining a sub-destination associated with the destination; and
causing the sub-destination to be sent to the electronic device over the data network.

32-51. (canceled)
